(19) United States
(12) Patent Application Publication
(10) Pub. No.: US 2025/0367805 A1
(43) Pub. Date: Dec. 4, 2025

(54) ADAPTER FOR POWER TOOL

(71) Applicant: MILWAUKEE ELECTRIC TOOL CORPORATION, Brookfield, WI (US)

(72) Inventor: Hunter S. Karlen, Hartford, WI (US)

(21) Appl. No.: 19/220,680

(22) Filed: May 28, 2025

Related U.S. Application Data
(60) Provisional application No. 63/653,464, filed on May 30, 2024.

(51) Int. Cl. B25D 17/00; B25D 17/02

(52) U.S. Cl. CPC B25D 17/005; B25D 17/02; B25D 2222/72; B25D 2250/095

(57) ABSTRACT

An adapter for coupling a tool bit to a power tool including a power tool housing. The adapter including an adapter housing configured to be coupled to the power tool housing and an input shaft supported by the adapter housing and defining an input axis. The input shaft is configured to be operably coupled to the power tool to receive rotary motion and axial impacts from the power tool. The adapter further includes a spindle supported by the adapter housing along an output axis oriented at an angle relative to the input axis and a transmission assembly operably coupled to the input shaft. The transmission assembly is configured to transfer rotary motion from the input shaft to the spindle for rotation of the tool bit. Moreover, the adapter includes an impact assembly having a wedge configured to transfer axial impacts from the input shaft to the tool bit.

### CROSS-REFERENCE TO RELATED APPLICATIONS

The present application claims priority to U.S. Provisional Patent Application No. 63/653,464, filed May 30, 2024, the entire contents of which are incorporated herein by reference.

### FIELD OF THE INVENTION

The present invention relates to accessories for power tools, and more particularly to accessories for rotary hammers.

### BACKGROUND OF THE INVENTION

Power tools, such as rotary hammers, include an axial impact mechanism having a reciprocating piston disposed within a spindle, a striker that is selectively reciprocable within the spindle in response to reciprocation of the piston, and an anvil that is impacted by the striker when the striker reciprocates toward the tool bit.

### SUMMARY OF THE INVENTION

The present invention provides, in one aspect, an adapter for coupling a tool bit to a power tool. The adapter includes an input shaft defining an input axis, and a spindle configured to receive the tool bit and defining an output axis. The output axis is angled relative to the input axis. The adapter is configured to transfer both rotation and impacts from the input shaft to the spindle.

The present invention provides, in another aspect, an adapter for coupling a tool bit to a power tool including a power tool housing. The adapter includes an adapter housing configured to be coupled to the power tool housing, and an input shaft supported by the adapter housing and defining an input axis. The input shaft is configured to be operably coupled to the power tool to receive rotary motion and axial impacts from the power tool. The adapter further includes a spindle supported by the adapter housing along an output axis oriented at an angle relative to the input axis. The spindle is configured to receive the tool bit. Additionally, the adapter includes a transmission assembly supported by the adapter housing and operably coupled to the input shaft. The transmission assembly is configured to transfer rotary motion from the input shaft to the spindle for rotation of the tool bit. Moreover, the adapter includes an impact assembly supported by the adapter housing. The impact assembly includes a wedge configured to transfer axial impacts from the input shaft to the tool bit.

The present invention provides, in another aspect, an adapter for coupling a tool bit to a power tool including a power tool housing. The adapter includes an adapter housing configured to be coupled to the power tool, and an input shaft supported by the adapter housing and defining an input axis. The input shaft is configured to be operably coupled to the power tool to receive rotary motion from the power tool. The adapter further includes a spindle supported by the adapter housing along an output axis oriented at an angle relative to the input axis. The spindle is configured to receive the tool bit. Additionally, the adapter includes a transmission assembly supported by the adapter housing and operably coupled to the input shaft. The transmission assembly is configured to transfer rotary motion from the input shaft to the spindle for rotation of the tool bit. Moreover, the adapter includes an impact assembly supported by the adapter housing. The impact assembly includes a cam plate coupled to the input shaft for co-rotation about the input axis. The cam plate is configured to be rotated by the input shaft to impart impacts to the tool bit.

The present invention provides, in another aspect, an adapter for coupling a tool bit to a power tool. The adapter includes an adapter housing having a support frame and a top cover coupled to the support frame. The support frame is formed of a first material and the top cover is formed of a second material that is less rigid than the first material. The adapter further includes a tool housing attachment coupled to the support frame of the adapter housing and configured to be removably coupled to the power tool, and an input shaft supported by the adapter housing and defining an input axis. The input shaft is configured to be operably coupled to the power tool. Moreover, the adapter includes a spindle supported by the adapter housing along an output axis oriented at an angle relative to the input axis. The spindle is configured to receive the tool bit. Additionally, the adapter includes a transmission assembly supported by the adapter housing and positioned between the input shaft and the spindle. The transmission assembly is configured to transfer rotary motion from the input shaft to the spindle for rotation of the tool bit. Furthermore, the adapter includes an impact assembly supported by the adapter housing and positioned between the input shaft and spindle. The impact assembly is configured to impart impacts to the tool bit via movement of the input shaft.

### BRIEF DESCRIPTION OF DRAWINGS

FIG. 1 is a side view of a rotary hammer.

FIG. 2 is a perspective view of an adapter for use with the rotary hammer of FIG. 1, according to an embodiment of the invention.

FIG. 3 is another perspective view of the adapter of FIG. 2 without the rotary hammer of FIG. 1.

FIG. 4 is a perspective view of the adapter of FIG. 2 with portions removed.

FIG. 5 is a perspective view of a housing attachment for coupling the adapter of FIG. 2 to the rotary hammer of FIG. 1.

FIG. 6 is a cross-sectional view of the adapter of FIG. 2 taken along line 6-6 in FIG. 2.

FIG. 7 is a cross-sectional view of a spindle and a tool bit of the adapter of FIG. 2 taken along line 7-7 in FIG. 6.

FIG. 8 is a perspective view of the adapter of FIG. 2 without a housing, the adapter including an impact assembly and a transmission assembly.

FIG. 9 is a perspective view of a wedge of the impact assembly of FIG. 8.

FIG. 10 is a perspective view of an adapter for use with the rotary hammer of FIG. 1, according to another embodiment of the invention.

FIG. 11 is another perspective view of the adapter of FIG. 10 without the rotary hammer of FIG. 1.

FIG. 12 is a perspective view of the adapter of FIG. 10 with portions removed.

FIG. 13 is a cross-sectional view of the adapter of FIG. 10 taken along line 13-13 in FIG. 10.

FIG. 14 is a perspective view of the adapter of FIG. 10 without a housing, the adapter including an impact assembly and a transmission assembly.

FIG. 15 is an enlarged view of the impact assembly of FIG. 14.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

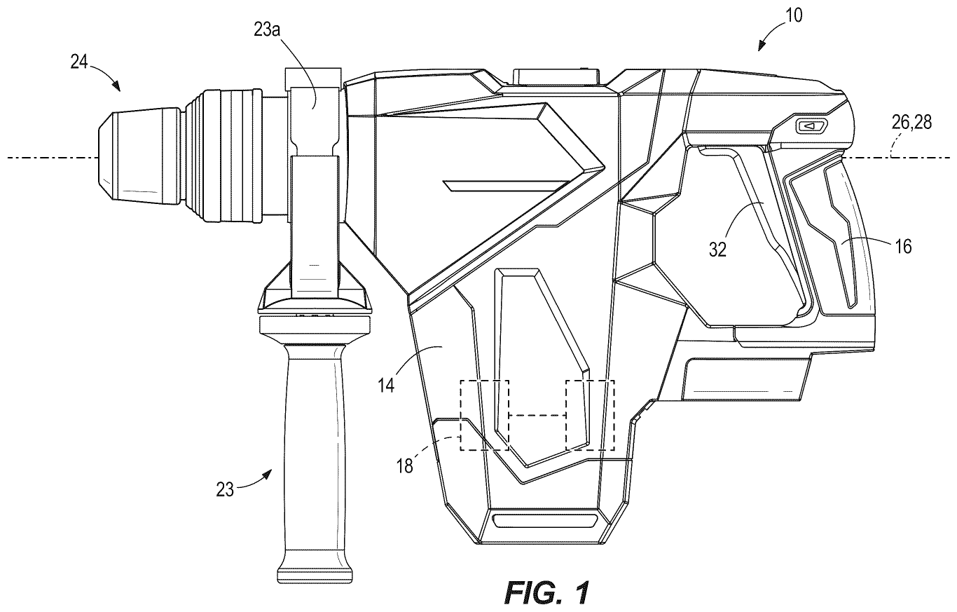

FIG. 1 illustrates a rotary power tool, such as rotary hammer 10. The illustrated rotary hammer 10 is just one example of a power tool. The rotary hammer 10 includes a housing 14, a rear handle 16, a motor 18 disposed within the housing 14, and a rotatable spindle (not shown) coupled to the motor 18 for receiving torque from the motor 18. The rear handle 16 may be referred to as a D-shaped handle as it forms a closed loop with the housing 14. An auxiliary handle 23 is removably coupled to the front of the housing 14 by a clamp ring 23a or other suitable coupling mechanisms. The housing 14 includes a chuck or quick release mechanism 24 coupled for co-rotation with the spindle to facilitate quick removal and replacement of different tool bits. The tool bit may include a necked section or a groove in which a detent member of the chuck 24 is received to constrain axial movement of the tool bit to the length of the necked section or groove. The rotary hammer 10 defines a tool bit axis 26, which is coaxial with a rotational axis 28 of the spindle.

The motor 18 is configured as a DC motor that receives electrical current from an on-board power source (e.g., a battery, not shown). The battery may include any of a number of different nominal voltages (e.g., 12V, 18V, etc.) and may be configured having any of a number of different chemistries (e.g., lithium-ion, nickel-cadmium, etc.). In some embodiments, the battery is a battery pack removably coupled to the housing 14. Alternatively, the motor 18 may be powered by a remote power source (e.g., a household electrical outlet) through a power cord. The motor 18 is selectively activated by depressing an actuating member, such as a trigger 32, which in turn actuates an electrical switch. The switch is electrically connected to the motor 18 via a top-level or master controller, or one or more circuits, for controlling operation of the motor 18.

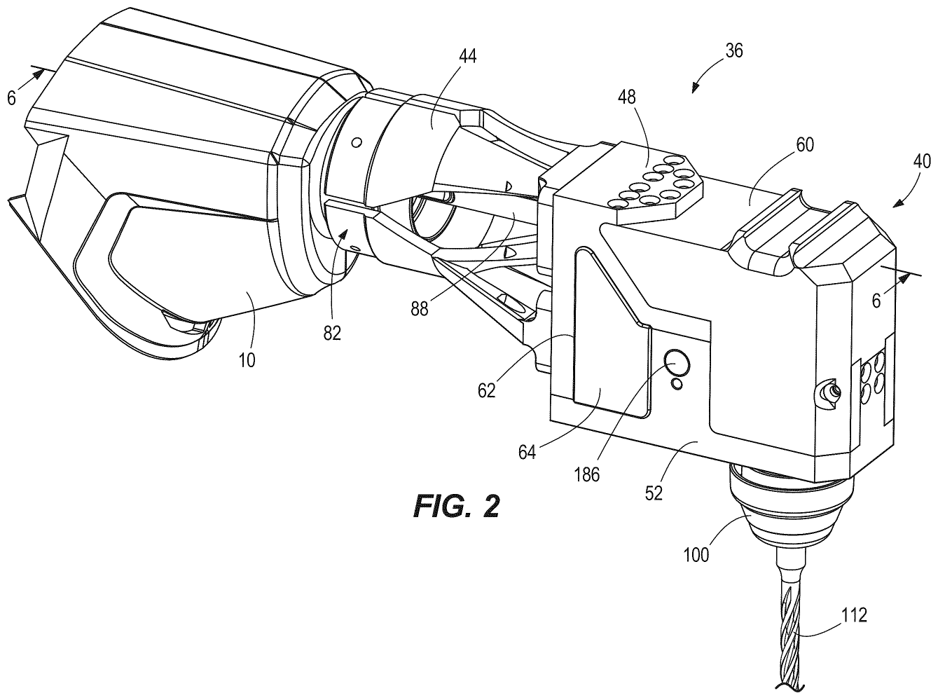

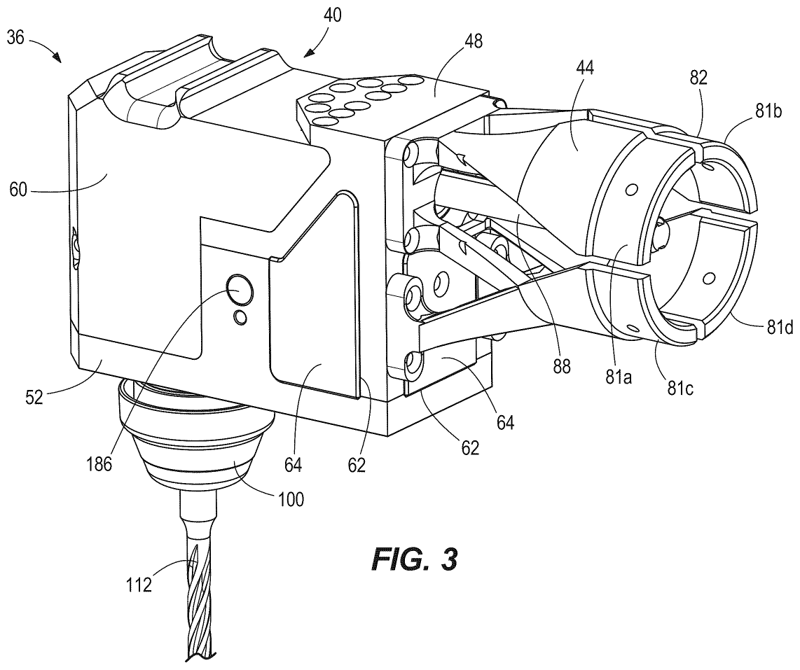

FIGS. 2-4 illustrate an adapter 36 for use with the rotary hammer 10. In other embodiments, the adapter 36 may be used with alternative power tools such as a nailer, drill, or the like. The adapter 36 includes a housing 40 and a tool housing attachment 44. The tool housing attachment 44 is coupled to and extends from the housing 40 and is configured to removably couple the adapter 36 to the rotary hammer 10.

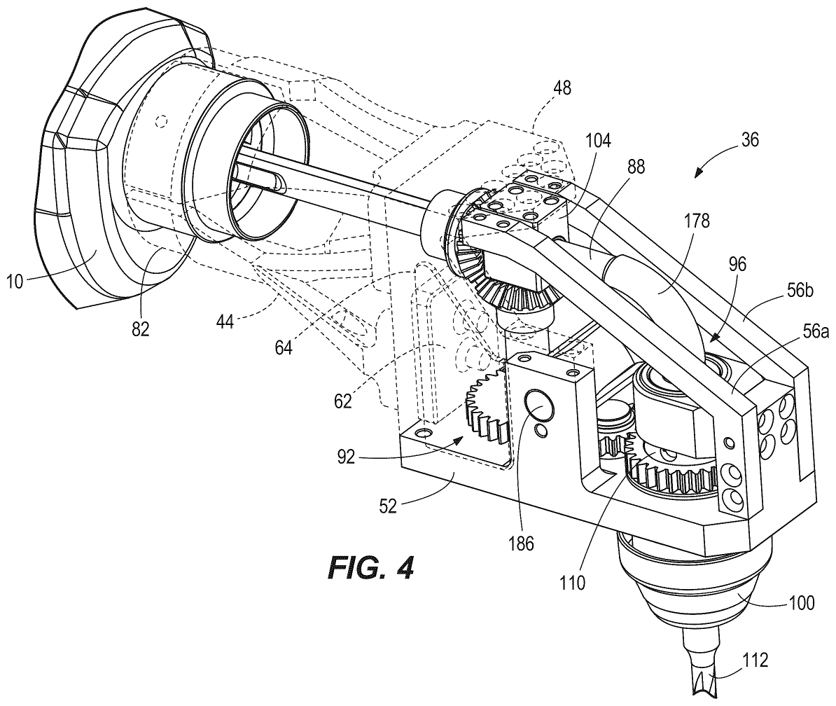

With respect to FIG. 4, the housing 40 includes a rear support frame 48 coupled to the tool housing attachment 44, a base plate 52 coupled to the rear support frame 48, and two support brackets 56a, 56b respectively coupled to the rear support frame 48 and the base plate 52 to further provide structural support and secure the rear support frame 48 to the base plate 52. The housing 40 further includes a top cover 60 coupled to the support brackets 56a, 56b and the rear support frame 48. In the illustrated embodiment, the rear support frame 48, the base plate 52, the support brackets 56a, 56b, and the top cover 60 of the housing 40 are fastened to each other via fasteners (e.g., screws, not shown).

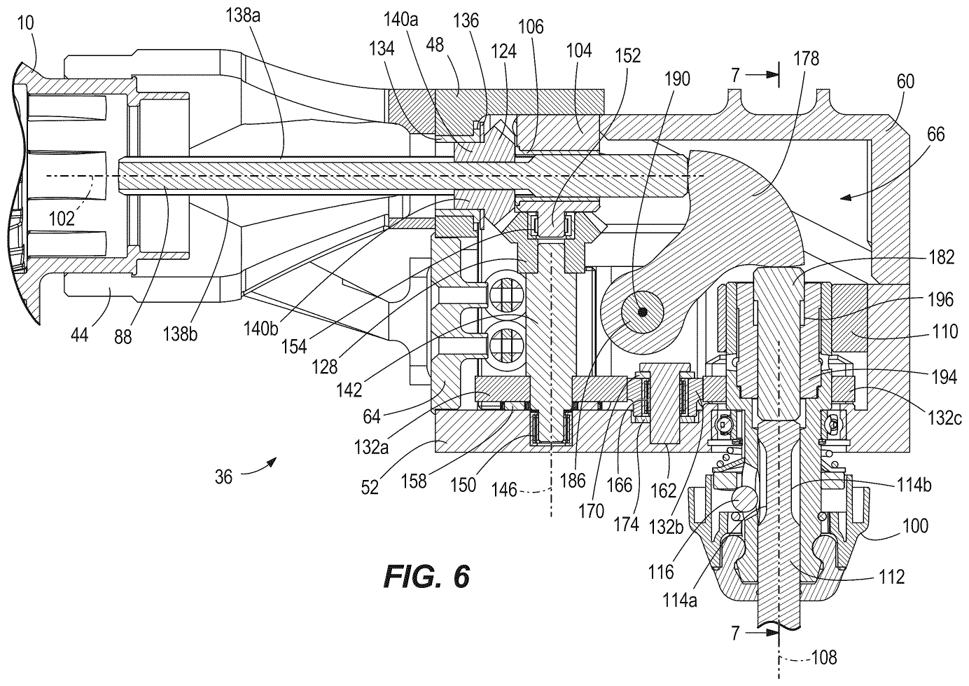

Multiple openings 62 are defined between the rear support frame 48 and the base plate 52. A plurality of plugs or panels 64 of the housing 40 are respectively inserted into the openings 62 to seal the openings 62 and protect the housing 40 of the adapter 36 from debris created during operation. The plugs 64 are connected to each other to prevent removal and formed of a plastic material. As such, a cavity 66 (FIG. 6) of the housing 40 is defined by the rear support frame 48, the base plate 52, the top cover 60, and the plurality of plugs 64.

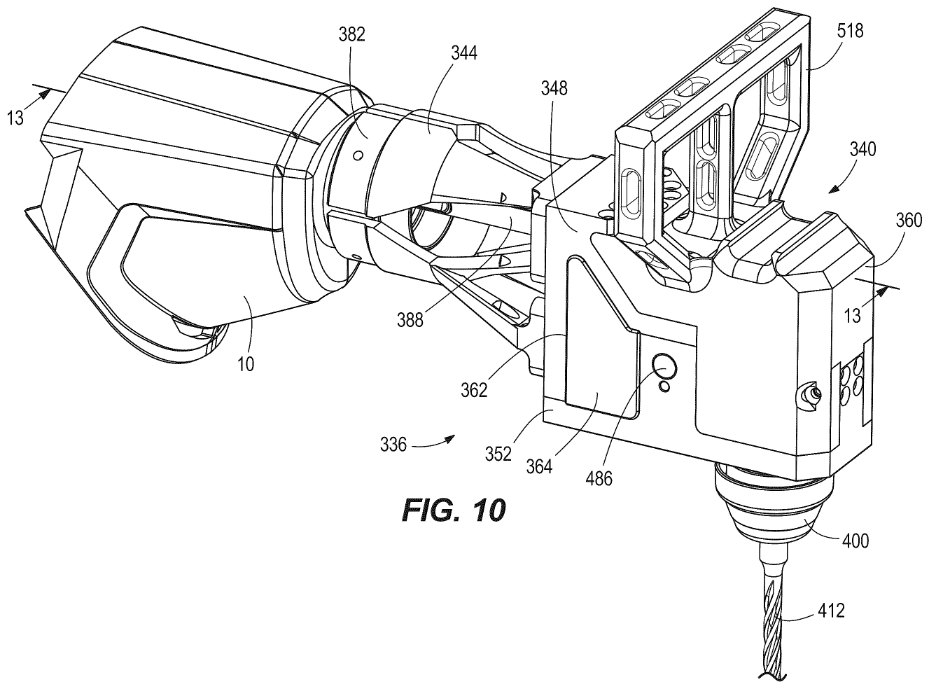

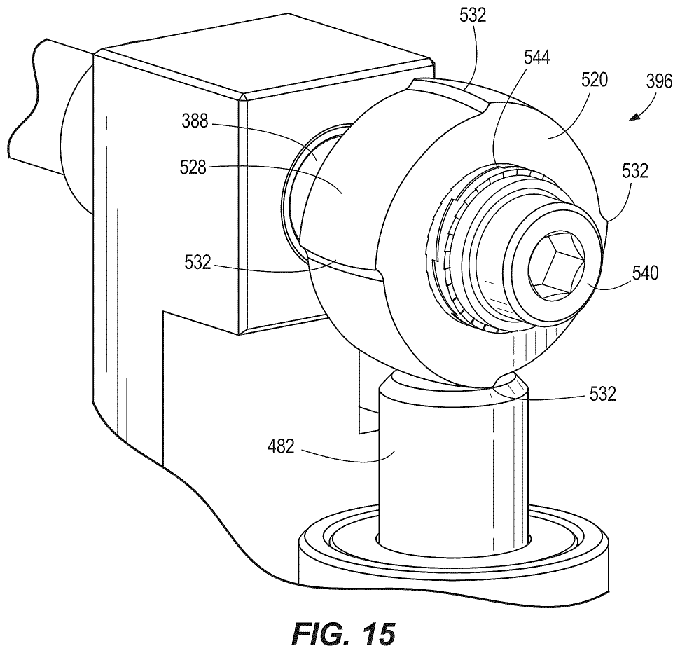

In the illustrated embodiment, the tool housing attachment 44, the rear support frame 48, the base plate 52, and the support brackets 56a, 56b are formed of a first material (e.g., steel) while the top cover 60 is formed of a second material (e.g., a plastic material or the like) that is less rigid that the first material. In some embodiments, the housing 40 may be composed of other materials such as aluminum, copper, rubber, or the like. In other embodiments, the housing 40 of the adapter 36 may be provided as a single piece of steel or other metal. In additional embodiments, the top cover 60 may be provided with a handle configured to be grasped by a user during operation of the rotary hammer 10 and similar to a handle 518 as discussed below with respect to FIGS. 10-15.

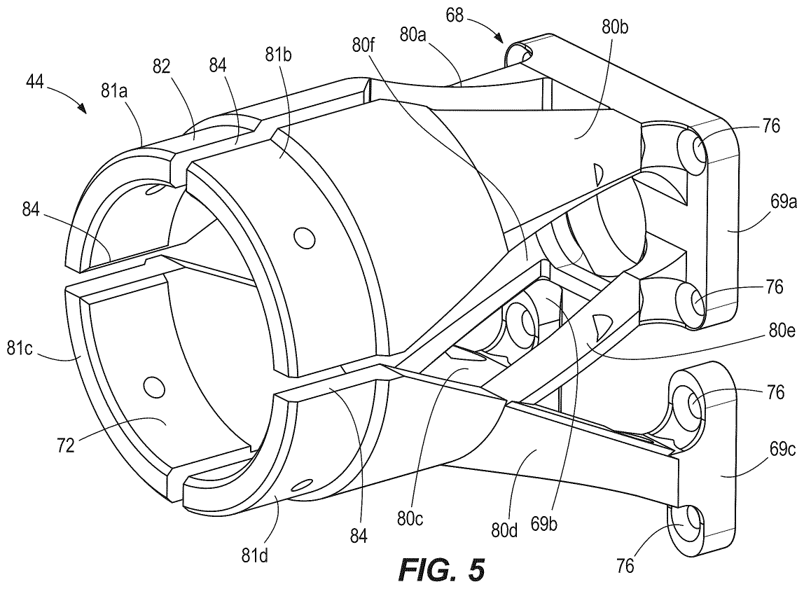

With reference to FIG. 5, the tool housing attachment 44 includes a fastening portion 68 and a clamping portion 72 configured to be removably coupled to the rotary hammer 10. The fastening portion 68 has support members 69a, 69b, 69c that are configured to couple the tool housing attachment 44 to the housing 40. In the illustrated embodiment, the fastening portion 68 includes a first support member 69a, a second support member 69b, and a third support member 69c. Each of the support members 69a, 69b, 69c includes fastening holes 76 extending therethrough and configured to respectively receive fasteners (e.g., screws) to couple the tool housing attachment 44 to the rear support frame 48. Each of the support members 69a, 69b, 69c includes clamping leg 80a, 80b, 80c, 80d coupled thereto and extending therefrom. In the illustrated embodiment, a first clamping leg 80a extends from the first support member 69a, a second clamping leg 80b extends from the first support member 69a, a third clamping leg 80c extends from the second support member 69b, and a fourth clamping leg 80d extends from the third support member 69c. In the illustrated embodiment, support legs 80e, 80f extend between the first support member 69a and the respective third and fourth clamp leg 80d, 80c. Each of the clamp legs 80a, 80b, 80c, 80d includes a clamping end opposite the support member 69a, 69b, 69c. The clamp ends collectively define the clamping portion 72. As shown, each of the clamp ends includes a recessed surface 81a, 81b, 81c, 81d. Collectively the recessed surfaces 81a, 81b, 81c, 81d define a recessed area 82 to which the clamp ring 23a of the auxiliary handle 23 may be coupled to attach the tool housing attachment, and therefore the adapter 36, to the rotary hammer 10. In other embodiments, a clamping ring without an auxiliary handle may be used to attach the tool housing attachment, and therefore the adapter 36, to the rotary hammer 10. In still other embodiments, the tool housing attachment 44 may be coupled in other suitable ways (e.g., a snap fit engagement with the housing, fasteners, etc.). Each of the clamping legs 80a, 80b, 80c, 80d is spaced apart from the adjacent legs by a slot 84 to permit expansion and contraction of the tool housing attachment 44. Accordingly, the tool housing attachment 44 is capable of coupling to different sized power tools. In other or alternative embodiments, there may be greater or fewer support members and/or greater or fewer clamping legs and/or support legs.

With reference to FIGS. 4 and 6-8, the adapter 36 further includes an input shaft 88, a transmission assembly 92, an impact assembly 96, and a spindle 100 that are each supported by the housing 40 of the adapter 36 and disposed within the cavity 66 of the housing 40. The spindle 100 is configured to receive and retain the tool bit 112 configured to perform work on a workpiece, such as concrete. The input shaft 88 defines an input axis 102 (FIG. 6) and extends outward from the housing 40 of the adapter 36 to be operably coupled to the rotary hammer 10 via the quick release mechanism 24. A support block 104 is fixed to the rear support frame 48 and has a sleeve bearing 106 configured to support sliding movement of the input shaft 88. The transmission assembly 92 is configured to transfer rotation from the input shaft 88 to the spindle 100 for rotation of the tool bit 112. The impact assembly 96 is configured to transfer axial impacts from the input shaft 88 to the tool bit 112.

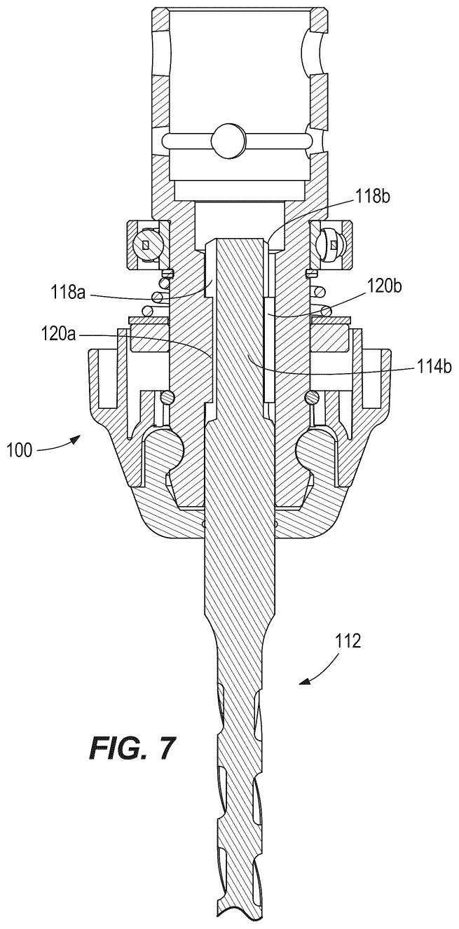

The spindle 100 defines an output axis 108 (FIG. 6) and extends from the housing 40 of the adapter 36. The output axis 108 is oriented at angle relative to the input axis 102. The angle may range between 0 degrees and 180 degrees. Preferably, the angle may be about 90 degrees, as shown in the illustrated embodiment. A first thrust bearing 110 is fixed to the base plate 52 and configured to support the spindle 100 as the spindle 100 extends outward from the housing 40 of the adapter 36. The tool bit 112 has a pair of recesses 114a, 114b defined on opposite sides of the tool bit 112 such that a detent ball 116 of the spindle 100 engages either one of the recesses 114a, 114b to rotatably couple the tool bit 112 to the spindle 100. The tool bit 112 also has a pair of grooves 118a, 118b (FIG. 7) configured to engage respective projections 120a, 120b extending from the spindle 100, such that the tool bit 112 is configured to reciprocate within the spindle 100.

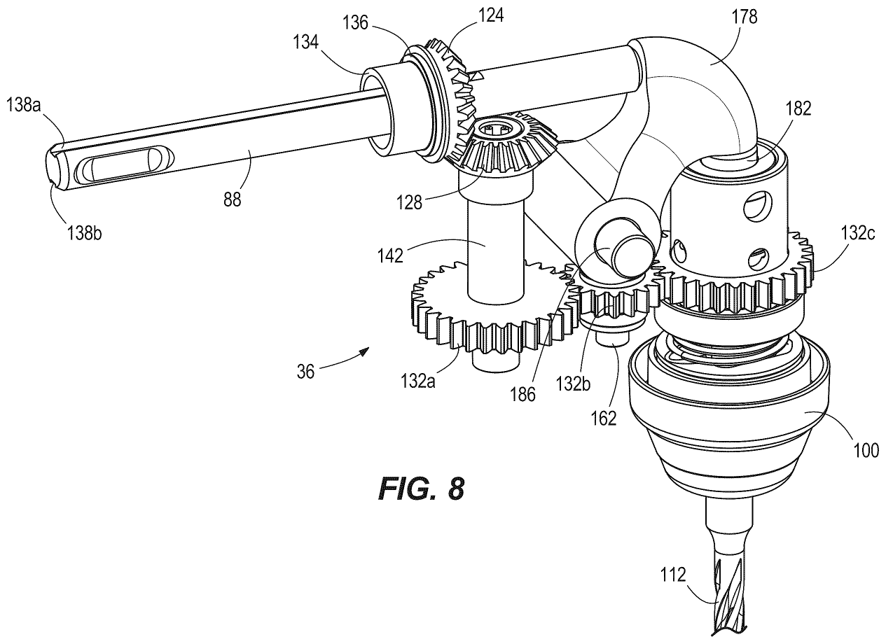

The transmission assembly 92 includes an input gear 124, an intermediate gear 128, and a plurality of output gears 132a-c. The input gear 124 and the intermediate gear 128 are bevel gears while the output gears 132a-c are spur gears. The input gear 124 is coupled to the input shaft 88 for co-rotation about the input axis 102 and is supported by a second thrust bearing 134. Also, a first thrust washer 136 is provided between the input gear 124 and the second thrust bearing 134 to further support the input gear 124. The input shaft 88 has a pair of keyways 138a, 138b (FIGS. 6 and 8) configured to cooperate with a pair of keys 140a, 140b (FIG. 6) formed along the input gear 124. As such, the input shaft 88 is permitted to co-rotate with the input gear 124 and slide in a direction parallel to the input axis 102 relative to the input gear 124.

The intermediate gear 128 is coupled to a drive shaft 142 for co-rotation about an intermediate axis 146. In the illustrated embodiment, the intermediate axis 146 is oriented transverse (e.g., perpendicular) to the input axis 102 and parallel to the output axis 108. The drive shaft 142 is coupled to the base plate 52 while a first needle bearing 150 is disposed therebetween to rotatably support the drive shaft 142. The intermediate gear 128 and the drive shaft 142 are constrained by the support block 104. As shown, the intermediate gear 128 and the drive shaft 142 are permitted to rotate about a projection 152 of the support block 104. A second needle bearing 154 is disposed between the projection 152 and the intermediate gear 128 to support rotation of the intermediate gear 128. The intermediate gear 128 is configured to engage the input gear 124 to transfer rotary motion from the input shaft 88 to the drive shaft 142.

The plurality of output gears 132a-c is positioned proximate the base plate 52 and includes a drive gear 132a, an idler gear 132b, and a driven gear 132c. The drive gear 132a is coupled to the drive shaft 142 for co-rotation about the intermediate axis 146. A third thrust bearing 158 is disposed between the drive gear 132a and the base plate 52 to support the drive gear 132a along the base plate 52. A pin 162 is fixed to the base plate 52 and axially constrains the idler gear 132b. A third needle bearing 166 is provided between the idler gear 132b and the pin 162 to support rotation of the idler gear 132b about the pin 162. In addition, a second thrust washer 170 is arranged between the idler gear 132b and the pin 162 while a third thrust washer 174 is arranged between the base plate 52 and the idler gear 132b. The driven gear 132c is coupled to the spindle 100 for co-rotation about the output axis 108. The drive gear 132a meshes with the idler gear 132b, which also meshes with the driven gear 132c. As such, the plurality of output gears 132a-c is configured to transfer rotary motion from the drive shaft 142 to the spindle 100. The idler gear 132b is provided between the drive gear 132a and the driven gear 132c to maintain a proper drilling direction of the tool bit 112. In other embodiments, the transmission assembly 92 may include fewer or more gears.

With continued reference to FIGS. 4 and 6-8, the impact assembly 96 includes a wedge 178 and a striker 182. The wedge 178 is pivotable about an axle 186 that is fixed to the base plate 52. The axle 186 defines an axis 190 extending in a direction transverse (e.g., perpendicular to) the input axis 102. As such, the wedge 178 is configured to receive axial impacts from the input shaft 88 to rotate about the axle 186 and impart impacts to the striker 182. The striker 182 is disposed within a spindle bearing 194 of the spindle 100 and configured to reciprocate along the output axis 108. The spindle bearing 194 has an abutment surface 196 configured to limit an amount the striker 182 is able to travel within the spindle 100. As such, the striker 182 transfers the impacts from the wedge 178 to the tool bit 112.

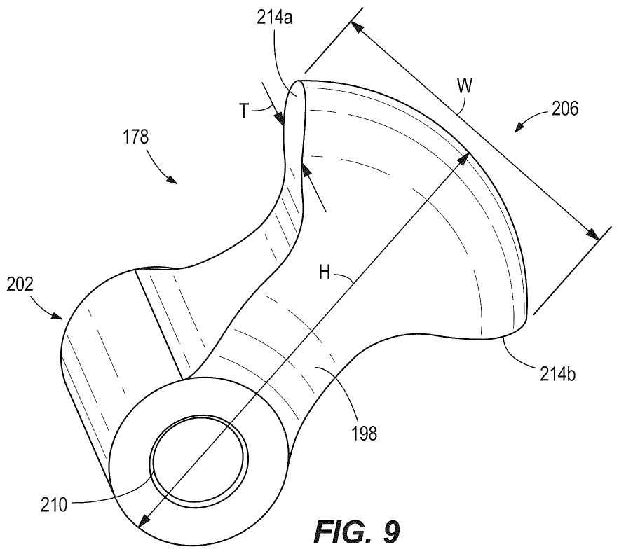

With reference to FIG. 9, the wedge 178 includes a body 198 defining a first end 202 and a second end 206 of the wedge 178. An axle hole 210 is defined through the first end 202 of the wedge 178 and configured to receive the axle 186 to couple the wedge 178 to the axle 186 for rotation. The second end 206 of the wedge 178 has a first impact surface 214a and a second impact surface 214b. Each impact surface 214a, 214b may define a radius that ranges from, but is not limited to, 20 mm to 120 mm. The second end 206 has a generally arcuate shape between the first and second impact surfaces 214a, 214b. The second end 206 therefore defines a radius that is approximately 27 mm in the illustrated embodiment. In other embodiments, the radius may range from 10 mm to 50 mm. Also, a length of an arc of the second end 206 is approximately 10 mm to 50 mm. In the illustrated embodiment, each of a maximum height H and maximum width W of the wedge 178 may be 27 mm and range from 10 mm to 50 mm. The first impact surface 214a is proximate the input shaft 88 to receive axial impacts from the input shaft 88 and cause the wedge 178 to rotate about the axle 186. The second impact surface 214b is proximate the striker 182 to impart impacts to the striker 182 when the wedge rotates about the axle 186.

A ratio of a diameter of the input shaft 88 to a thickness T of the wedge 178 may range from 0.83 to 1. A ratio of a radius of the input shaft 88 to a radius of a respective impact surface 214a, 214b of the wedge 178 may be optimized. A ratio of a total mass of the input shaft 88 to a total mass of the wedge 178 and/or the tool bit 112 may also be optimized.

With reference back to FIGS. 4 and 6-8, the input shaft 88 is operably coupled to the rotary hammer 10 during operation to receive axial impacts and rotary motion therefrom. In particular, a user may operate the rotary hammer 10 in a hammer-drill mode or a drill-only mode. In the hammer-drill mode, the rotary hammer 10 rotates the input shaft 88 and imparts axial impacts to the input shaft 88. Rotary motion of the input shaft 88 is transferred to the spindle 100 by the transmission assembly 92 for rotation of the spindle 100. When the input shaft 88 receives axial impacts from the rotary hammer 10, the input shaft 88 is permitted to slide relative to the input gear 124 and impart axial impacts to the wedge 178. The wedge 178 then rotates about the axle 186 and impart impacts to the striker 182, which then reciprocates within the spindle 100 to impact, and therefore reciprocate, the tool bit 112. As such, the hammer-drill mode allows the tool bit 112 to rotate into and impact a workpiece via rotational and axial, reciprocating movement. In a drill-only mode, the rotary hammer 10 only rotates the input shaft 88 such that the transmission assembly 92 transfers rotary motion from the input shaft 88 to the spindle 100. As such, the tool bit 112 is only permitted to rotate into a workpiece in the drill-only mode.

The adapter 36 is operably coupled to the rotary hammer 10 to change a direction in which the tool bit axis 26 of the rotary hammer is oriented. As such, the adapter 36 arranges the tool bit 112 in a different direction to allow the user to perform work on surfaces in different orientations.

FIGS. 10-15 illustrate another adapter 336 for use with a power tool, such as the rotary hammer of FIG. 1. The adapter 336 is similar to the adapter 36 of FIGS. 2-9; therefore, like structure will be identified by like reference number plus “300” and only the differences will be discussed hereafter.

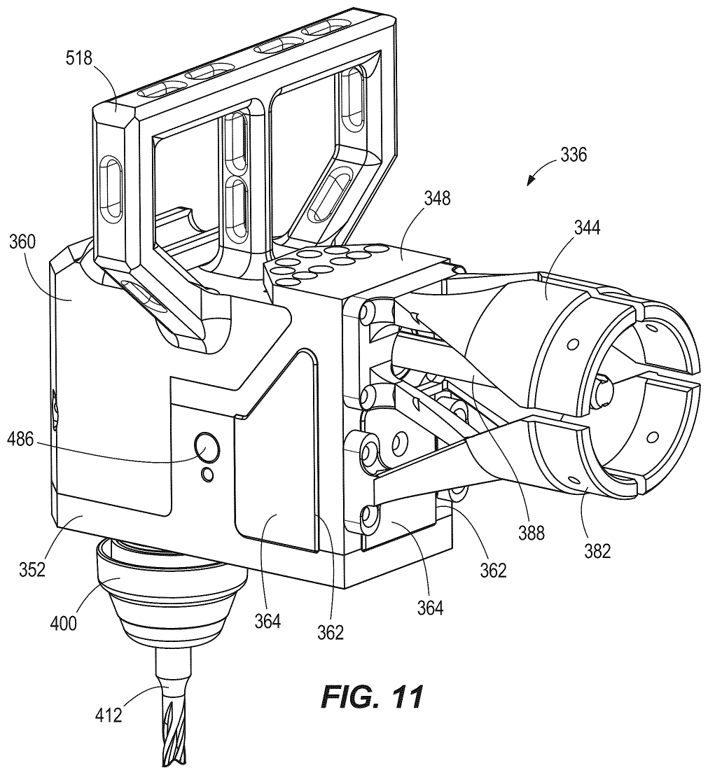

Like the adapter 36, the adapter 336 includes a housing 340 and a tool housing attachment 344. With reference to FIGS. 10 and 11, the top cover 360 has a handle 518 configured to be grasped by a user during operation. In other embodiments, the top cover 360 may be provided without a handle while the rotary hammer 10 has a handle.

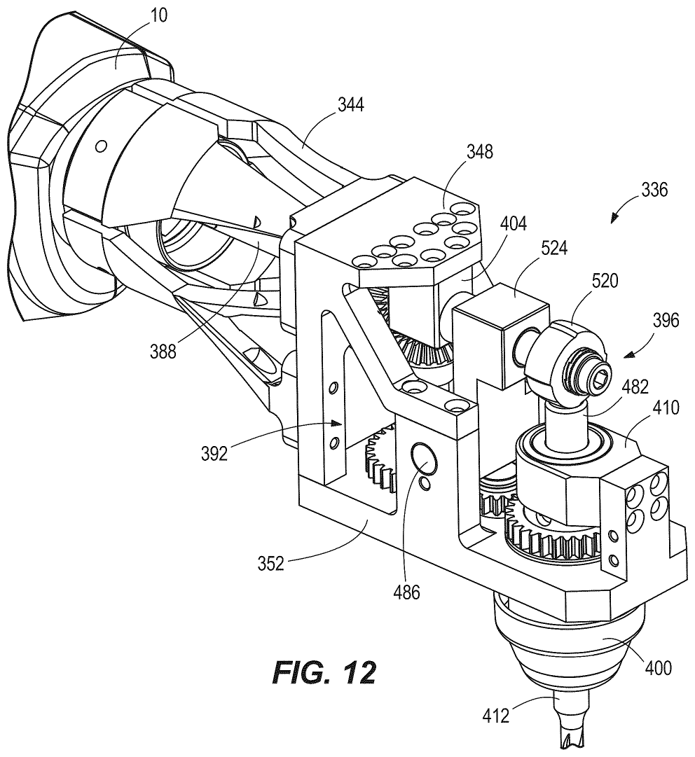

With reference to FIGS. 12-15, the adapter 336 includes an input shaft 388, a transmission assembly 392, an impact assembly 396, and a spindle 400 that are each supported by the housing 340 of the adapter 336 and disposed within the cavity 366 of the housing 340. The impact assembly 396 of the adapter 336 includes a striker 482, a cam plate 520, and a shaft support member 524.

The cam plate 520 has a circular shape and an exterior surface 528 with a plurality of projections 532 extending radially therefrom. In the illustrated embodiment, the cam plate 520 has four projections 532. In the illustrated embodiment, the projections 532 are positioned relative to one another by approximately 90 degrees. In other embodiments, the cam plate 520 may have less than or more than four projections 532. If there are less than four projections 532, the distance between adjacent projections 532 may be greater such that they are positioned relative to one another by greater than 90 degrees. If there are more than four projections 532, the distance between adjacent projections may be less such that they are positioned relative to one another by less than 90 degrees. Additionally, the projections 532 are spaced apart from one another by distances that are equal. In other embodiments, the projections 532 may be spaced apart from one another by distances that are variable. As shown, the projections 532 extend radially from the exterior surface 528 of the cam plate 520 by a distance of 0.75 mm. The distance may range from 0.1 mm to 3 mm. Therefore, the first radius of the cam plate 520 when measured to the exterior surface 528 thereof is 12 mm, while the second radius of the cam plate 520 defined by the distal ends of the projections 532 is 30 mm. The first radius may range from 5 mm to 120 mm. A central hole 534 is defined through the cam plate 520 with a hexagonal cross-section. A coupling portion 536 of the input shaft 388 has a hexagonal shape and is configured to be received by the central hole 534 to couple the cam plate 520 to the input shaft 388 for co-rotation about the input axis 402. In other embodiments, the cam plate 520 and the input shaft 388 may have other geometry suitable for coupling the cam plate 520 to the input shaft 388 for co-rotation, such as cooperating key and keyway geometry.

The cam plate 520 is secured to the input shaft 388 by a bolt 540 configured to be threadably coupled to the coupling portion 536 of the input shaft 388. A lock washer 544 is arranged between the cam plate 520 and the bolt 540 to prevent an unfastening action of the bolt 540. As such, the cam plate 520 is configured to rotate with the input shaft 388 such that the projections 532 consecutively engage the striker 482 to impart impacts to the striker 482 for operation of the tool bit 412.

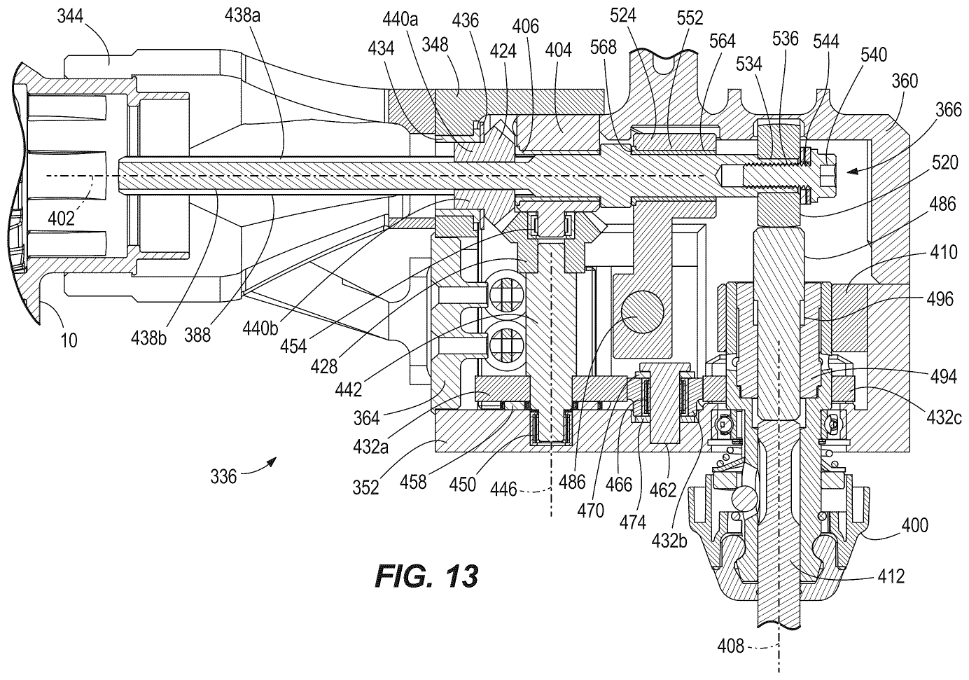

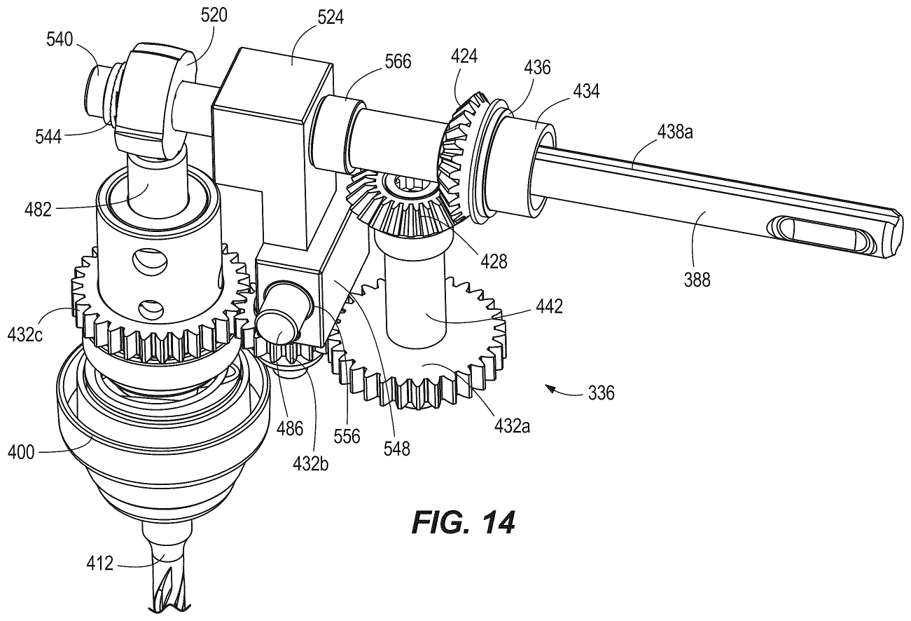

The shaft support member 524 includes an axle portion 548 (FIG. 14) and an input portion 552 (FIG. 13) integrally formed with the axle portion 548. The axle portion 548 defines a first hole 556 extending therethrough and configured to receive the axle 486. The axle 486 constrains the shaft support member 524 relative to the housing 340. The input portion 552 defines a second hole 564 extending therethrough and is configured to receive the input shaft 388. A sleeve bearing 568 is disposed between a surface of the second hole 564 and the input shaft 388. As such, the shaft support member 524 provides further structural support to at least a portion of the input shaft 388 that is disposed between the support block 404 and the cam plate 520. Also, a flange 566 of the input shaft 388 is fixed between the support block 404 and the input portion 552 of the shaft support member 524 to prevent axial movement of the input shaft 388.

The striker 482 is operably coupled to the spindle 400 and arranged adjacent the cam plate 520 to receive impacts therefrom. More specifically, the striker 482 is disposed within the spindle bearing 494 of the spindle 400 to reciprocate along the output axis 408. The abutment surface 496 of the spindle bearing 494 limits an amount at which the striker 482 travels within the spindle 400. As such, the striker 482 is configured to transfer impacts from the cam plate 520 to the tool bit 412.

During operation, the input shaft 388 is coupled to the rotary hammer 10 and receives rotary motion to be rotated about the input axis 402. The transmission assembly 392 rotates in response to rotation of the input shaft 388, and thereby rotates the spindle 400 and the tool bit 412. The cam plate 520 of the impact assembly 396 also rotates in response to rotation of the input shaft 388 to impart impacts to the striker 482, which then moves within the spindle 400 to impact the tool bit 412. As such, the transmission assembly 392 and the impact assembly 396 are operable such that the tool bit 412 rotates into and impacts a workpiece via rotational and axial movement.

Although the invention has been described in detail with reference to certain preferred embodiments, variations and modifications exist within the scope and spirit of one or more independent aspects of the invention as described.

Various features of the invention are set forth in the following claims.

What is claimed is:

1. An adapter for coupling a tool bit to a power tool including a power tool housing, the adapter comprising:
an adapter housing configured to be coupled to the power tool housing;
an input shaft supported by the adapter housing and defining an input axis, the input shaft configured to be operably coupled to the power tool to receive rotary motion and axial impacts from the power tool;
a spindle supported by the adapter housing along an output axis oriented at an angle relative to the input axis, the spindle configured to receive the tool bit;
a transmission assembly supported by the adapter housing and operably coupled to the input shaft, the transmission assembly configured to transfer rotary motion from the input shaft to the spindle for rotation of the tool bit; and
an impact assembly supported by the adapter housing, the impact assembly including a wedge configured to transfer axial impacts from the input shaft to the tool bit.

2. The adapter of claim 1, wherein the wedge is configured to receive axial impacts from the input shaft to rotate about a rotational axis transverse the input axis to impart impacts to the tool bit.

3. The adapter of claim 1, wherein the impact assembly further includes a striker operably coupled to the spindle, the striker configured to transfer impacts from the wedge to the tool bit.

4. The adapter of claim 1, wherein the transmission assembly includes an input gear coupled to the input shaft for co-rotation about the input axis, an intermediate gear coupled to a drive shaft and engageable with the input gear, and an output gear operably coupled to the drive shaft to transfer rotary motion from the drive shaft to the spindle for rotation of the tool bit.

5. The adapter of claim 4, wherein the drive shaft is oriented parallel to the output axis.

6. The adapter of claim 4, wherein the output gear is one of a plurality of output gears, and wherein the plurality of output gears includes a drive gear coupled to the drive shaft for co-rotation, a driven gear coupled to the spindle for co-rotation about the output axis, and an idler gear configured to transfer rotary motion from the drive gear to the driven gear.

7. The adapter of claim 1, wherein the adapter housing includes a tool housing attachment including a clamping portion that is configured to allow the adapter housing to contract and expand to couple to the power tool housing.

8. The adapter of claim 1, wherein the angle is about 90 degrees.

9. An adapter for coupling a tool bit to a power tool including a power tool housing, the adapter comprising:
an adapter housing configured to be coupled to the power tool;
an input shaft supported by the adapter housing and defining an input axis, the input shaft configured to be operably coupled to the power tool to receive rotary motion from the power tool;
a spindle supported by the adapter housing along an output axis oriented at an angle relative to the input axis, the spindle configured to receive the tool bit;
a transmission assembly supported by the adapter housing and operably coupled to the input shaft, the transmission assembly configured to transfer rotary motion from the input shaft to the spindle for rotation of the tool bit; and
an impact assembly supported by the adapter housing, the impact assembly including a cam plate coupled to the input shaft for co-rotation about the input axis, the cam plate configured to be rotated by the input shaft to impart impacts to the tool bit.

10. The adapter of claim 9, wherein the impact assembly further includes a striker operably coupled to the spindle, the striker configured to transfer impacts from the cam plate to the tool bit.

11. The adapter of claim 10, wherein the cam plate has circular cross-section with one or more projections extending from an exterior surface of the cam plate and configured to impact the striker.

12. The adapter of claim 9, further comprising a support member configured to support at least a portion of the input shaft.

13. The adapter of claim 9, wherein the transmission assembly includes an input gear coupled to the input shaft for co-rotation about the input axis, an intermediate gear coupled to a drive shaft and engageable with the input gear, and an output gear operably coupled to the drive shaft to transfer rotary motion from the drive shaft to the spindle for rotation of the tool bit.

14. The adapter of claim 13, wherein the drive shaft is oriented parallel to the output axis.

15. The adapter of claim 13, wherein the output gear is one of a plurality of output gears, and wherein the plurality of output gears includes a drive gear coupled to the drive shaft for co-rotation, a driven gear coupled to the spindle for co-rotation about the output axis, and an idler gear configured to transfer rotary motion from the drive gear to the driven gear.

16. The adapter of claim 9, wherein the adapter housing includes a tool housing attachment including a clamping portion that is configured to allow the adapter housing to contract and expand to couple to the power tool housing.

17. The adapter of claim 9, wherein the angle is about 90 degrees.

18. An adapter for coupling a tool bit to a power tool, the adapter comprising:
an adapter housing including a support frame and a top cover coupled to the support frame, the support frame formed of a first material and the top cover formed of a second material that is less rigid than the first material;
a tool housing attachment coupled to the support frame of the adapter housing and configured to be removably coupled to the power tool;
an input shaft supported by the adapter housing and defining an input axis, the input shaft configured to be operably coupled to the power tool;
a spindle supported by the adapter housing along an output axis oriented at an angle relative to the input axis, the spindle configured to receive the tool bit;
a transmission assembly supported by the adapter housing and positioned between the input shaft and the spindle, the transmission assembly configured to transfer rotary motion from the input shaft to the spindle for rotation of the tool bit; and
an impact assembly supported by the adapter housing and positioned between the input shaft and the spindle, the impact assembly configured to impart impacts to the tool bit via movement of the input shaft.

19. The adapter of claim 18, wherein the impact assembly includes a wedge configured to transfer axial impacts from the input shaft to the tool bit.

20. The adapter of claim 18, wherein the impact assembly includes a cam plate coupled to the input shaft for co-rotation about the input axis, the cam plate configured to be rotated by the input shaft to impart impacts to the tool bit.
